(19) United States
(12) Patent Application Publication
(10) Pub. No.: US 2019/0149557 A1
(43) Pub. Date: May 16, 2019

(54) METHOD AND INTEGRITY CHECKING SYSTEM FOR DECOUPLED INTEGRITY MONITORING

(71) Applicant: SIEMENS AKTIENGESELLSCHAFT, München (DE)

(72) Inventor: RAINER FALK, POING (DE)

(73) Assignee: SIEMENS AKTIENGESELLSCHAFT, München (DE)

(21) Appl. No.: 16/097,845

(22) PCT Filed: Apr. 26, 2017
(86) PCT No.: PCT/EP2017/059861

§ 371 Date: Oct. 31, 2018

(30) Foreign Application Priority Data
May 2, 2016 (DE) 10 2016 207 546.2

(51) Int. Cl. H04L 29/06

(52) U.S. Cl. CPC H04L 63/123; H04L 9/0643; H04L 63/1416; H04L 63/105

(57) ABSTRACT

Provided is a method and an integrity checking system having an integrity checking unit and an integrity reporting unit for perturbation-free integrity monitoring of at least one first device, which is arranged in a first network having a high security requirement, by an integrity checking device, which is arranged in a second network having a low security requirement, having the method steps of: -providing check information for the data of the first device—that are to be monitored to an integrity checking device by means of a perturbation-free one-way communication unit, -checking the check information in the second network against at least one piece of reference information, and- transmitting a status report to an integrity reporting device in the first network.

### CROSS-REFERENCE TO RELATED APPLICATIONS

This application claims priority to PCT Application No. PCT/US2017/059861, having a filing date of Apr. 26, 2017, based off of German Application No. 10 2016 207 546.2, having a filing date of May 2, 2016, the entire contents both of which are hereby incorporated by reference.

### FIELD OF TECHNOLOGY

The following relates to a method for decoupled integrity monitoring of at least one first device, which is arranged in a network having a high security requirement, by an integrity checking device, which is arranged in a second network having a low security requirement, and to an integrity checking system having an integrity checking device and an integrity reporting device.

### BACKGROUND

Security solutions for the transmission of data between networks having different security requirements, what are known as cross domain security solutions, have been used to date for specific areas, such as communication by authorities. These areas have high security requirements in force, in particular for documents with security classification. A cross domain solution, as in DE 10 2013 226 171, for example, effects automated secure exchange of documents and messages between zones having different levels of security requirements.

The document EP 2 801 937 A1 describes a method for checking system variables using reference variables in a cloud platform. A check certificate confirming a system condition with reference to or in comparison with “baseline data” is issued in the face of one or more criteria. The data of the system to be checked are transmitted to the control system in the cloud, a one way communication unit also being able to be used.

The document US 2009/002150 A1 describes a method for transmitting data from sensors in a secured network via a one way communication interface. The transmitted data are processed in a control center in a second network and the test results are returned via a separate channel.

On the other hand, automation networks have high requirements in terms of dependability, i.e. trouble-free and safe-to-use operation of the individual components, and in terms of realtime capability, availability and integrity, and have thus been planned and operated as insulated subnetworks. Industrial control networks of this kind are coupled to an office network, a public internet or a diagnosis network, which usually meet only low security requirements, using unidirectional data gateways having transmission and reception nodes, for example, as described in US 2012 0331 097 A1. A fundamental component in this case is a data diode, which ensures transport of data only in one direction.

Industrial control networks are coupled to an office network or other less security-relevant networks also using conventional firewalls, which filter the data communication according to configurable filter rules. Firewalls are also known that render a Windows drive of an automation network visible as a read only drive on the other side of the firewall, for example in the less security-critical network, that is to say mirror the drive in this case. This allows the content of the network drive to be analyzed for viruses and inadmissible changes outside the automation network. The data communication is then permitted or blocked on the basis of the addresses of the communication partners and the communication protocol used.

It is moreover known practice to route a network connection via an application proxy terminating a TCP connection, for example, at transport level. However, such solutions do not guarantee decoupling in the requisite quality.

In security-critical networks, such as a railway protection network, for example, the integrity of the data communication and integrity of the software running on the various devices and components need to be ensured in order to guarantee safe operation. This needs to be realized with a high level of reliability in particular in security-critical networks used for functional safety. Conventional firewalls are not suited to this purpose. It must firstly be ensured that communication of data from the security-relevant network to a less security-relevant network is performed in decoupled fashion. This decoupling means that the transmission does not introduce any kind of data into the security-critical network. Secondly, any new software relating to the data communication in the security-critical network must be licensed by an official body. Such licensing usually takes several days up to weeks or even months. This hampers the use of updated virus patterns for monitoring the individual network components within the security-critical network, for example.

### SUMMARY

An aspect relates to ensure integrity monitoring for the data communication and the software configuration of devices in a security-critical network without in the process introducing additional data into the security-critical network or disturbing the communication within the security-critical networks.

The method according to embodiments of the invention for decoupled integrity monitoring of at least one first device, which is arranged in a first network having a high security requirement, by an integrity checking device, which is arranged in a second network having a low security requirement, has the following method steps:
providing check information for the data that are to be monitored for the first device to an integrity checking device by means of a decoupled one way communication unit,
checking the check information in the second network in comparison with at least one piece of reference information,
transmitting a status report to an integrity reporting device, which is designed as an automation device in a first network designed as an automation system, in the first network,
providing additional metadata for all the data to be monitored for the integrity checking unit and checking the completeness of the provided data on the basis of the metadata, wherein the metadata contain at least one characteristic value and at least one cryptographic checksum.

The decoupled one way communication unit can in this case comprise, by way of example, a data diode that, by way of example, as an eavesdropping device, copies the data transmitted only in the security-relevant first network and discharges them to the second network, or may be formed by a unidirectionally transmitting optical fiber. This ensures the requirement of decoupling. The check information from the first network can now be checked in the second network, thus without the security-dependent limitations of the first network, also in comparison with new virus patterns or in comparison with a positive list for executable files, etc. It is therefore possible for a check to be performed at any time and in comparison with any reference information. The transmission of a status report to an integrity reporting device in a first network provides a first acknowledgement to the security-critical network, which can be evaluated therein and reacted to. Therefore, there is improved integrity within the self-contained security-critical first network.

In an advantageous embodiment, configuration data and/or executable files and/or characteristic values derived therefrom are provided as check information.

It is therefore possible for manipulated software, for example, in particular inadmissibly introduced executable files, to be detected. A manipulation of the first device by new virus software can also be traced much earlier by up-to-date virus scanners outside the first network, since it is not necessary to wait for up-to-date virus scanners of this kind to be licensed for the, by way of example, restricted-licensing first network. The transmission of measured values derived from the configuration data or perhaps executable files allows the magnitude of the check information to be greatly reduced. Such measured values are, by way of example, hash values for the check information that explicitly denote the configuration data or executable files.

In the present embodiment, additionally metadata for all the data to be monitored are provided to the integrity checking unit and the metadata are used to check the completeness of the provided data.

This leads to a high level of reliability and ensures that actually all the data to be monitored are provided for checking. Such metadata can be transmitted in the form of a manifest file, for example, as used for distributing Java class libraries and Java programs, for example.

In addition, the metadata contain at least one characteristic value for check data and at least one cryptographic checksum for the at least one characteristic value of the check data, and/or a piece of up-to-dateness information for the metadata.

This in turn guarantees the integrity of the metadata and, for example using a timestamp as up-to-dateness information, indicates the time of capture at which the check information was compiled and therefore also active.

In an advantageous configuration, the reference information is at least one piece of setpoint data information or at least one malware pattern.

A piece of setpoint data information may be a positive list of all the files licensed for the first device, for example, in particular all the licensed executable files. In particular in the case of self-contained networks, a piece of setpoint data information is known via licensing protocols, for example. A check on the check information contained in the first device, in particular implemented software, outside the security-critical network means that the reference information is not subject to licensing requirements. The software implemented on the first device can therefore be checked in particular in comparison with unlicensed reference information, such as up-to-date malware patterns (patchable virus scanners), for example.

In an advantageous embodiment, the status report is transmitted to an integrity reporting device via a return channel of the one way communication unit.

This has the advantage that measures can be initiated in the first network promptly on the basis of the reported status. As such, by way of example, warnings can be distributed to all the other components of the first network or functions can be deactivated. It is also possible for a security level within the first network to be set and communicated as appropriate that in turn has an influence on the performance of particular functionalities. An integrity reporting device may in particular be a standard component in the first network. By way of example, the integrity reporting device may be a field device, in particular a sensor, that can forward the received status report within the first network using a protocol used during conventional operation.

In an advantageous embodiment, the status report is transmitted from a loading server in the second network to the at least one first unit via a loading interface.

This has the advantage that the introduction of data into the first network via the standard route of the loading server is used and therefore no additional new interface, which would in turn need to be monitored, is required.

In an advantageous embodiment, the status report is taken as a basis for initiating measures in the first and/or in the second network.

As such, an automation system can react to an integrity violation by activating a limited emergency mode or by assuming a failsafe operating condition, for example. In a failsafe operating condition, only one faulty component is deactivated without paralyzing the whole system. Measures such as e.g. short-term provision of new configuration data can be taken in the second network.

In an advantageous embodiment, monitoring is effected in the second network in order to determine whether relevant data are actually contained in the check information and a check has actually been performed by the integrity checking device.

This ensures with a high level of reliability that the integrity check is actually effected. It therefore becomes possible to detect the feigning of a check or failure of the check. If a desired check is detected as not performed, then this likewise suggests a manipulation in the first network and measures can be initiated.

The integrity checking system according to embodiments of the invention for decoupled integrity monitoring of at least one first device, which is arranged in a first network having a high security requirement, comprises a one way communication unit and an integrity checking device, wherein the one way communication unit is designed so as to transmit the check information from the first device to the integrity checking device, which is arranged in a second network having a low security requirement, and the integrity checking device is designed so as to check the check information in comparison with at least one piece of reference information.

The integrity checking system is therefore arranged outside the security-critical first network and thus does not need to be regarded as decoupled for the dependability licensing. This allows it to be updated flexibly. The integrity checking system is in particular designed so as to carry out a method according to the described features.

An integrity checking device according to embodiments of the invention for decoupled integrity monitoring of at least one first device comprises a reception unit designed so as to receive check information and to output a piece of status information. It moreover comprises a memory unit designed so as to store reference information. Moreover, the integrity checking device comprises an evaluation unit designed so as to check the check information in comparison with the reference information.

An integrity reporting device according to embodiments of the invention for decoupled integrity monitoring of at least one first device is designed as an automation device in a first network designed as an automation system.

This allows simple transmission of a piece of status information within the first network and therefore fast distribution and reaction thereto.

Moreover, a computer program product (non-transitory computer readable storage medium having instructions, which when executed by a processor, perform actions) is claimed that is directly loadable in a programmable computer and comprises program code portions suitable for performing the steps of the method.

### BRIEF DESCRIPTION

Some of the embodiments will be described in detail, with references to the following Figures, wherein like designations denote like members, wherein:

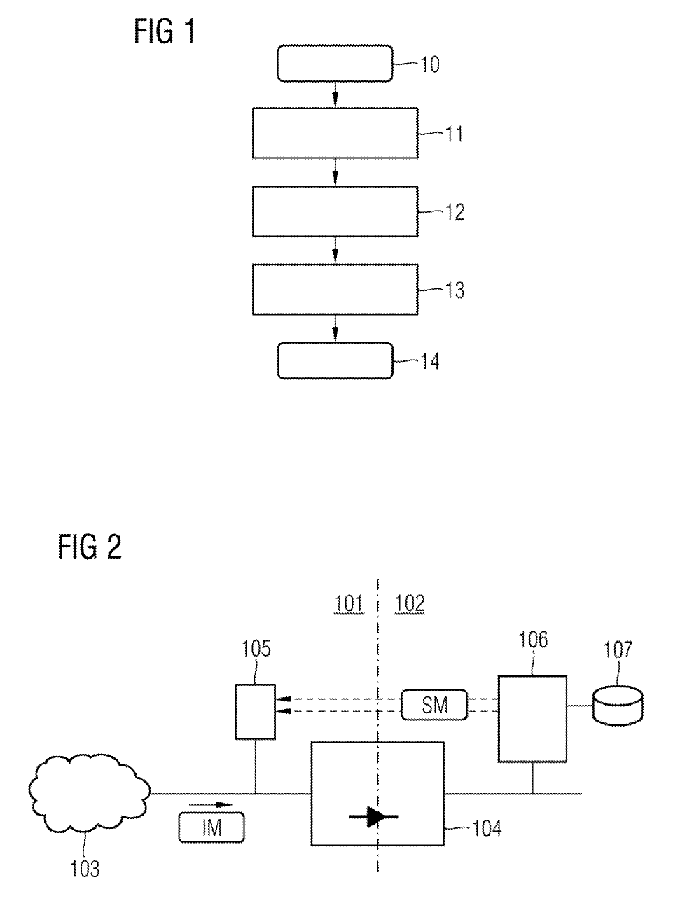

FIG. 1 shows an exemplary embodiment of the method in the form of a flowchart;

FIG. 2 shows a first security-relevant network, coupled to a second, less security-critical, network, with a first exemplary embodiment of an integrity checking system in a schematic depiction;

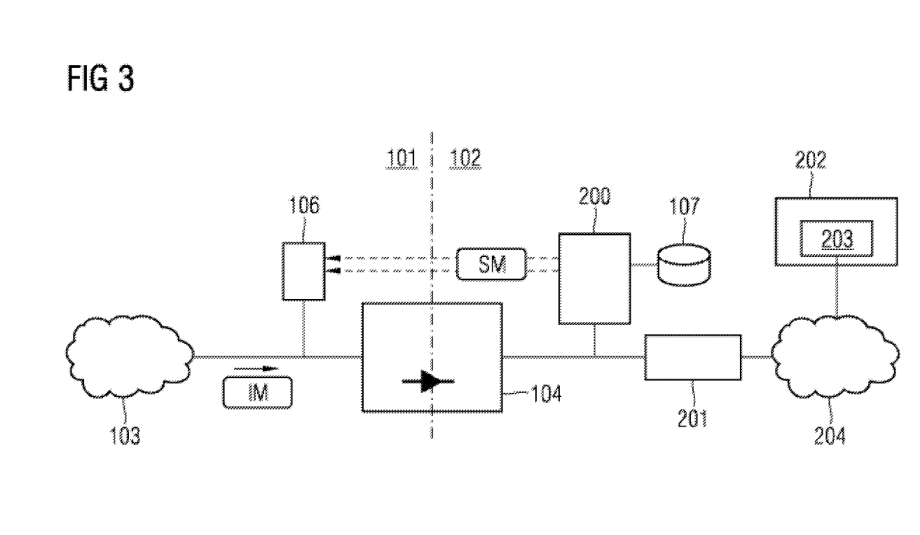

FIG. 3 shows a second exemplary embodiment of an integrity checking system with a separate integrity checking device in a schematic depiction; and

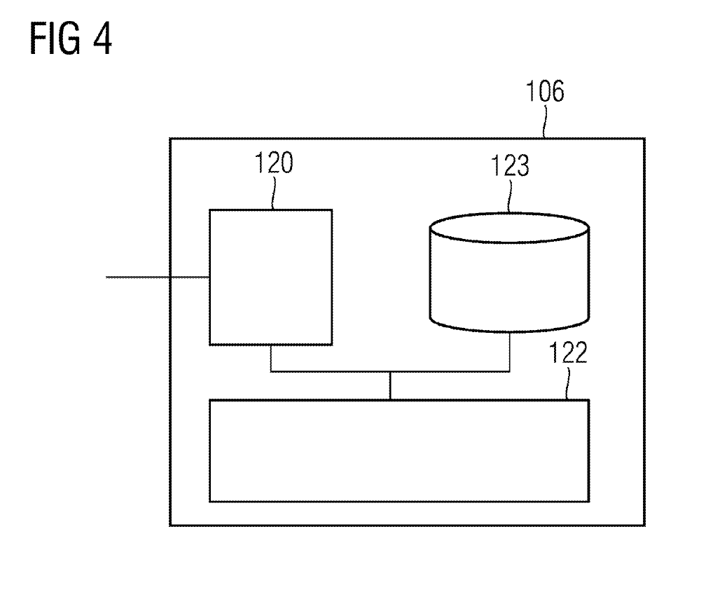

FIG. 4 shows an exemplary embodiment of an integrity checking device in a block diagram.

Parts that correspond to one another are provided with the same reference signs throughout the figures.

### DETAILED DESCRIPTION

A flowchart in FIG. 1 will now be used to describe a solution for decoupled integrity monitoring of the devices of a first security-critical network, for example an automation system. In the initial condition 10, there is at least one device in a first network having a high security requirement. Said at least one device may be, by way of example, field devices or components of a railway protection network, such as, for example, driving signals, barriers or perhaps points, which are controlled by means of a control computer, for example, that is likewise arranged in the self-contained railway protection network. Messages are exchanged between these devices and in the first network. Each device comprises microprocessors configured with software in order to perform a wide variety of functions.

In order to be able to ensure the integrity of these components, the data transmitted between the devices can firstly be checked. In embodiments of the present invention, in particular the software present in the individual devices is checked for integrity as well. Information pertaining to the contained software of a device used for the integrity check is subsequently referred to as check information.

For integrity monitoring, these first devices provide check information to an integrity checking device, which is arranged in a second, less security-relevant, network, such as an office network, for example, in method step 11. As check information, a device in the first network transmits, by way of example, its configuration data and/or its executable files and/or characteristic values derived therefrom, such as, for example, a hash value for the configuration data or files. The transmission of the data in this case takes place via a decoupled one way communication unit, for example a data diode. In addition to the actual check information, metadata are preferably provided in order to ensure the completeness and correctness of the one way data. To this end, a manifest file having hash values for the data to be checked and a cryptographic checksum is transmitted, for example.

In the integrity checking device, the check information is now checked in comparison with at least one piece of reference information in method step 12. Such reference information is typically a piece of setpoint data information, such as, for example, a positive list of permitted executable files or a configuration level of the installed software of the device. This reference information is known in particular in self-contained networks and/or networks with licensing requirements. The check information can alternatively be checked against at least one malware pattern, in particular the most up to date virus patterns, as reference information.

In the event of an integrity violation, an alarm signal is transmitted to and provided in the first network by transmitting a status report, for example, see method step 13. Preferably, the status report is provided to the first network or automation system via a return channel, in particular in the form of an electrical switching signal or in the form of a data transmission using a further one way communication unit. A status report “OK” indicates check data verified as harmless. It is alternatively possible for an uncritical integrity violation or a critical integrity violation to be reported, which the first network can react to with different measures. As such, a limited emergency mode can be activated or a failsafe operating condition can be assumed, for example.

The reliability of the integrity check can be increased by what is known as a liveliness check. This involves monitoring whether check information is actually transmitted or an applicable message actually contains check information, and whether a check has actually been performed in the integrity checking device.

FIG. 2 shows an industrial automation and control system 103 operated in a first security-relevant network 101. All the components and devices in this first network 101 and also the software configuration thereof and application files are typically subject to licensing requirements. That is to say that the configuration of the devices or perhaps the software as an umbrella term for all the control programs or application programs can be introduced into the first network 101 only via specific loading servers, not depicted, and at particular times. The industrial automation and control system 103 comprises field devices, control computers, diagnosis computers and similar devices, for example. Typically, a first network 101 of this kind is very sensitive in terms of its dependability and requires realtime-critical data transmission between the devices. From the point of view of the network, the first network 101 is a self-contained network physically separate from external networks, such as, for example, the second network 102.

Coupling of the first network 101 to a less security-critical network 102, such as, for example, an office network of the automation network operator or perhaps to public networks such as the Internet or to a specific integrity monitoring network, is nevertheless desired in order to evaluate diagnosis reports, for example, or even to be able to check the software condition of the devices in the first network using the most up to date virus patterns in each case or perhaps other check information.

The one way communication device 104, for example a data diode or data sluice, allows just one data stream out of the first network 101. A one way communication device 104 of this kind then ensures that no kind of signals can be introduced into the first network 101 by the second network 102 in the opposite direction or perhaps can be generated by the one way communication unit 104 itself and entered into the first network.

Decoupled transmission of this kind can be effected by optical fibers or network output couplers, what are known as network taps, for example. The check information IM shown, which is provided by one or more or perhaps all devices of the network 103, is, by way of example, files, hash values for a file or perhaps hash values for multiple files containing configuration data or program code, for example. Check information IM can alternatively contain a list of the running software processes of a device or comprise monitoring data, what are known as log files.

An integrity checking device 106 in the second network 102 performs an integrity check on the check information IM. The checking device 106 additionally checks whether a requisite piece of check information IM is actually provided with data, and performs self-monitoring. In one variant, the check information IM comprises a piece of up-to-dateness information, e.g. a timestamp or a counter value, that is used to verify the up-to-dateness of the check information IM. The integrity checking device 106 thus checks whether a check on check information actually takes place. To this end, the integrity checking device 106 can have a watchdog that is reset whenever an integrity checking step is successfully executed. Such a watchdog is a unit that monitors the operation of other components. If a possible malfunction is detected in the process, then this is signaled as per system arrangement and a suitable jump instruction is initiated that clears up the relevant problem. The integrity checking device 106 is preferably connected to an integrity database 107 in which reference information pertaining to the integrity check, such as, for example, setpoint data information or malware patterns, is saved.

An integrity reporting device 105 is designed as a virtual sensor, for example, since it can be addressed like a conventional physical sensor within an automation and control system 103. This allows the status report to be called up and used in simple fashion, e.g. in the control program of a programmable logic controller. A virtual integrity sensor of this kind is, by way of example, an integrated circuit that can be addressed at appropriate contacts via what is known as a GPIO channel. These GPIO signals can be used to receive status reports, such as, for example, “Integrity Monitoring Running” or perhaps “Integrity OK”, and to forward them as sensor values to the automation and control network 103 and to provide them therein, e.g. using an OPC UA protocol or using a TCP/IP protocol or using an http protocol or using an MQTT, XMPP or AMQP protocol. Alongside GPIO signals, e.g. optical signal transmission is also possible, for example via an optical fiber.

The connection between an integrity checking unit 106 and the integrity reporting device 105 is designed as a return channel that is independent of the one way communication device 104. This return channel is used to transmit the status reports SM.

FIG. 3 now depicts a similar automation and control network 103 in a first security-critical network 101 from which check information IM is taken to a second, less security-critical, network via the one way communication unit 104. In the depicted variant, the integrity monitoring is not performed in the directly connected second network 103, but rather is performed by an integrity checking application 203 in a cloud platform 202. To this end, the check information IM will be provided by a cloud service or with the assistance of a cloud service. The check information IM is transmitted to the integrity checking application 203 by a local integrity checking unit 202 via a cloud connection unit 201 that sets up a secure data connection to the cloud platform 202. The data connection can be provided by a secure TLS protocol or an IPsec protocol, for example.

FIG. 4 shows an integrity checking device 106. This comprises a reception unit 120 via which the check information IM is provided to the integrity checking device 106. Moreover, the integrity checking device 106 comprises a memory unit 123, which stores reference information against which the check information IM is checked. The reception unit 120 and the reference database 123 are connected to an evaluation unit 122 in which the check information IM is checked in comparison with the reference information from the reference database 123. A status report can likewise be transmitted to the first network 101 via the reception unit 120.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for decoupled integrity monitoring of at least one first device, which is arranged in a first network having a high security requirement, by an integrity checking device, which is arranged in a second network having a low security requirement, the method comprising:
providing check information for the data that are to be monitored for the at least one first device to an integrity checking device by means of a decoupled one way communication unit;
checking the check information in the second network in comparison with at least one piece of reference information; and
transmitting a status report to an integrity reporting device, which is designed as an automation device in a first network designed as an automation system in the first network, and
providing metadata for all the data to be monitored for the integrity checking unit and checking the completeness of the provided data on the basis of the metadata, wherein the metadata contain at least one characteristic value of the check data and at least one cryptographic checksum for the at least one characteristic value of the check data.

2. The method as claimed in claim 1, wherein configuration data and/or executable files and/or characteristic values derived therefrom are provided as check information.

3. The method as claimed in claim 1, wherein the metadata contain at least one piece of up to dateness information for the metadata.

4. (canceled)

5. The method as claimed in claim 1, wherein the reference information is at least one piece of setpoint data information or at least one malware pattern.

6. The method as claimed in claim 1, wherein the status report is transmitted to an integrity reporting device via a return channel of the one way communication unit.

7. The method as claimed in claim 1, wherein the status report is transmitted from a loading server in the second network to the at least one first device via a loading interface.

8. The method as claimed in claim 7, wherein the status report is taken as a basis for initiating measures in the first and/or in the second network.

9. The method as claimed in claim 1, wherein monitoring is effected in the second network in order to determine whether relevant data are actually contained in the check information and a check has actually been performed by the integrity checking device.

10. An integrity checking system for decoupled integrity monitoring of at least one first device, which is arranged in a first network having a high security requirement, comprising a one way communication unit and an integrity checking device, wherein
the one way communication unit is designed so as to transmit check information from the first device to the integrity checking device, which is arranged in a second network having a low security requirement,
the integrity checking device is designed so as to check the check information in comparison with at least one piece of reference information, and,
the integrity checking device is designed so as to use provided metadata for all the data to be monitored to check the completeness of the provided data, wherein the metadata contain at least one characteristic value of the check data and at least one cryptographic checksum for the at least one characteristic value of the check data.

11. The integrity checking system as claimed in claim 10 having an integrity reporting device that is arranged in the first network and is designed so as to receive a status report from the integrity checking device.

12. The integrity checking system as claimed in claim 10, which is designed so as to carry out a method.

13. An integrity checking device for decoupled integrity monitoring of at least one first device, comprising a reception unit, which is designed so as to receive check information and to output a piece of status information, a memory unit, which is designed so as to store reference information, and an evaluation unit, which is designed so as to check the check information in comparison with the reference information.

14. An integrity reporting device for decoupled integrity monitoring of at least one first device as claimed in claim 1, wherein the integrity reporting device is designed as an automation device in a first network designed as an automation system.

15. A computer program product, comprising computer readable hardware storage device having computer readable program code stored therein, said program code executable by a processor of a computer system to implement a method directly loadable into a programmable computer, comprising program code portions suitable for performing the steps of the method as claimed in claim 1.
